(19) United States
(12) Patent Application Publication
(10) Pub. No.: US 2008/0160301 A1
(43) Pub. Date: Jul. 3, 2008

(54) Mica containing coating compositions, coated nonwoven fibrous mats, laminates and method

(76) Inventors: Malay Nandi, Littleton, CO (US); Souvik Nandi, Englewood, CO (US); Gaurav Agrawal, Aurora, CO (US)

Correspondence Address: JOHNS MANVILLE, 10100 WEST UTE AVENUE, PO BOX 625005, LITTLETON, CO, 80162-5005, US

(21) Appl. No.: 11/648,502

(22) Filed: Dec. 28, 2006

(51) Int. Cl. B32B 5/16; A21C 1/00; B32B 9/04; C04B 14/00; B32B 19/00

(52) U.S. Cl. 428/363; 106/400; 366/76.1; 428/357; 428/411.1; 428/454

(57) ABSTRACT

Coating compositions for fibrous nonwoven and woven coated mats comprising a platey filler, mica, talc, clay, etc., of particular critical mean particle sizes and aspect ratios, one or more pigments of particular particle sizes and a resin binder producing a good surface and low permeabilities achieved with low coating weights are disclosed. Also, disclosed are fibrous mats coated on at least one surface with the coating compositions and laminates having a coated fibrous mat bonded to at least one surface of the substrate of the laminate. The platey mica in the coating has a mean particle size of about 38+/−8 or less microns and an aspect ratio of about 36+/−7 or less.

The present invention involves coating compositions, containing particular amounts and particle sizes of mica, for coating fibrous nonwoven and woven mats with a low coating weight to control the air permeability of the coated mat as desired. The invention also involves the method of making the coating compositions. The coated fibrous mats of the invention are useful in bonding to various substrates to provide dimentional stability, reinforcement and a better surface containing little or no mold susceptible content for making a large number of products such as insulation composites or laminates of all types and for many uses, e.g. for making laminated products including duct board, wallboard, foam insulation board.

### BACKGROUND

It is known to make reinforcing nonwoven mats from fibers and to use these mats as substrates in the manufacture of a large number of products. Methods of making nonwoven mats are known, such as conventional wet laid processes described in U.S. Pat. Nos. 4,112,174, 4,681,802 and 4,810,576, the disclosures of which are hereby incorporated herein by reference. In these processes a slurry of glass fiber is made by adding fiber to a typical white water in a pulper to disperse the fiber in the white water forming a slurry having a fiber concentration of about 0.2-1.0 weight %, metering the slurry into a flow of white water to dilute the fiber concentration to 0.1 or below, and depositing this mixture on to a moving screen forming wire to dewater and form a wet nonwoven fibrous mat.

This wet nonwoven web of fiber is then transferred to a second moving screen in-line with the forming screen and run through a binder application saturating station where an aqueous binder mixture, such as an aqueous urea formaldehyde (UF) resin based binder mixture, is applied to the mat in any one of several known ways. The mat, binder saturated, is then run over a suction section while still on the moving screen to remove excess binder. The wet mat is then transferred to a wire mesh moving belt and run through an oven to dry the wet mat and to cure (polymerize) the UF based resin binder which bonds the fibers together in the mat. Preferably, the aqueous binder solution is applied using a curtain coater or a dip and squeeze applicator, but other methods of application such as spraying are also known.

In the drying and curing oven the mat is subjected to temperatures up to 450 or 500 degrees F. or higher for periods usually not exceeding 1-2 minutes and as little as a few seconds. Alternative forming methods for nonwoven fiber mats include the use of well known processes of cylinder forming, continuous strand mat forming which lays continuous strands of glass fibers in overlapping swirls, and “dry laying” using carding or random fiber distribution.

UF resins, usually modified with one or more of acrylic, styrene butadiene, or vinyl acetate resins, are most commonly used as a binder for glass fiber mats because of their suitability for the applications and their relatively low cost. Melamine formaldehyde resins are sometimes used for higher temperature and/or chemical resistant applications. To improve the toughness of the mats, a combination of higher mat tear strength and mat flexibility, which is needed to permit higher processing speeds on product manufacturing lines and for maximum product performance on the roofs and in other applications, it is common to modify or plasticize the UF resins as described above. The binder content of these finished mats typically are in the range of 15 to 25 weight percent or higher, based on the dry weight of the mat. It is also known to use other types of aqueous latex binders like acrylics, polyester, polyvinyl acetate, polyvinyl alcohol and other types of resinous binders alone or in combination.

The typical application for coated fibrous mats or facers include wallboard, ceiling tile, foam insulation board etc. The coating provides the required air permeability needed for different applications. For example, during the wallboard making process, coated fibrous mat is used to prevent the gypsum slurry from bleeding through the facer mat, however, the coated fibrous mat will allow water vapor to go through during the drying process. In general, the coating on the mat controls the air permeability needed for different applications. It also provides the aesthetic surface needed and produces a more handler friendly mat product, i.e. one that causes less itchiness. The major objective is the development of coating compositions that produce the required permeability at low coating weight to fulfill an economical need. The U.S. Pat. Nos. 4,784,897, 4,879,173, 5,112,678, 5,342,680, and 6,770,354 all describe mineral pigment based coating compositions. The typical coating compositions contain one or more mineral pigments such as calcium carbonate, clay, mica etc, and one or more polymeric latex and/or inorganic binders. However, the use of particular amounts and particle sizes of fillers, particularly of mica, to manipulate the air permeability is not discussed or known to the industry.

It is also known, as illustrated by U.S. Pat. No. 5,965,257 to make a closed or completely sealed off coated mat having no bleed through when used as a facer mat in the manufacture of foam insulation by heavily coating a dry, bonded mat on a separate coating line. This patent teaches a coating composition comprising one or more fillers and a binder like acrylic latex. It is also known to use off-line coating to make coated mats. It is also disclosed in U.S. Pat. Nos. 5,001,005 and 5,965,257 to make glass fiber mats containing 60-90 weight percent glass fibers 10-40 percent of non-glass filler material and 1-30 percent of a non-asphaltic binder to use as a facer for a foam substrate. The filler materials are bonded to the glass fibers with the binder and prevent bleed through of the foam precursor materials when the latter is placed in contact with the mat prior to blowing.

### SUMMARY OF THE INVENTION

Unique coating compositions have been discovered containing a significant amount of platey mica, of a mean particle size range and aspect ratio range, in combination with one or more pigments and one or more binders, the coating uniformly penetrates the fibrous mat only slightly and reduces air permeability significantly at low coating weight while also providing excellent surface smoothness. The range of mean particle size of mica used in the coating compositions is about 38 microns plus/minus 8 microns. The aspect ratio of the mica is about 36 plus/minus 7. Many types of pigments can be used in combination with the mica to reduce the permeability further. The type of pigments and/or fillers used with the platey mica is not important, but the mean particle size and width of the particle size distribution is important to achieving the best results.

This invention relies on the influence of the shape and size of mineral pigments and/or fillers to affect the application properties of the coating compositions and coatings, such as the rheology of the coating mixture and porosity of the coated mat. The surprising finding is the significant reduction in air permeability of the coated glass fiber mats with low coating weights of coating compositions having high PVC (pigment volume concentrations) and small percentages of platey mica having certain mean particle sizes and certain aspect ratios.

The coating compositions of the invention comprises a platey filler material having a mean particle size of about 38 microns+/−8 microns, one or more other pigments and/or fillers and a polymer binder. The platey filler is most typically mica, but can be any platey material in this particle size range and aspect ratio range, including talc and clay. Most typically, but not necessarily, the other pigments or fillers are a ground calcium carbonate material. Many other ground mineral fillers or pigments having similar particle sizes as described below can be used instead of calcium carbonate minerals.

Among the suitable binders for the coating composition are one or more of the following binders. Styrene/butadiene binders including GoodRite™ 0706 (styrene butadiene rubber latex), available from Noveon, Inc. located in Cleveland, Ohio, a choice when good flexibility of the coated sheet is important and acrylic resins including Rhoplex™ NW 1845, and particularly Hycar™ 26391, available from Rhom and Haas Co. of Philadelphia, Pa., when good UV resistance and high stiffness are desirable in the coated mat. Other resin binders suitable for the coating compositions include ethylene-vinyl chloride, polyvinylidenechloride, modified polyvinylchloride, polyvinyl alcohol, ethylene vinyl acetate, polyvinyl acetate, ethylacrylate-methylmethacrylate acrylic copolymer latex, non-carboxylated acrylic with acrylonitriles copolymer latex, carboxylated butyacrylic copolymer latex, urea-formaldehyde latex, melamine-formaldehyde latex, polyvinylchloride-acrylic latex, methylmethacrylate-styrene copolymer latex, styrene-acrylic copolymer latex, phenol-formaldehyde latex, vinyl-acrylic latex, polyacrylic acid latex and other similar resin binders. The criteria for selecting suitable binders are those that produce the required viscosity under both low and high shear in the coating composition. By required viscosity is meant a Brookfield viscosity in the range of about 10,000 centipoise to about 20,000 centipoise (3 RPM, Spindle No. 4), more typically a range of about 12,500 to about 17,500 centipoise and most typically about 15,000+/−up to 1,000 or up to 2,000 centipoise.

Fibrous coated mats of the present invention comprise coated mats having a permeability before coating in the range of from about 100-400 to about 1000 CFM/sq. ft. at a pressure drop of 0.5 inch of water and a coating of the above composition and a coating weight in the range of about 100 to about 500 gms/sq. meter, on at least one surface of the mat. More typically the coating weight will be substantially less than 500 gms/sq. meter. The fibrous nonwoven or woven mat substrates comprise glass or polymer fibers bonded together with an aqueous binder system containing a conventional resin binder, preferably a water compatible binder like modified urea formaldehyde, melamine formaldehyde, furan, polyvinyl alcohol, hydroxyl ethyl cellulose, carboxyl methyl cellulose, cellulose gums, polyvinyl pyrilidone, polyvinyl acetate homopolymer, etc., and other known ingredients for fibrous nonwoven mats. Typically the fiber is glass fiber, preferably K or H diameter fiber, but other fibers including synthetic fibers like nylon, polyester, polyethylene, etc. can be present in amounts up to 100 percent of the fibers, but more typically, when present will make up less than 25 wt. percent of the fibers. Also, a small amount of the fibers can be bleached cellulosic fibers or fibers derived from a cellulosic material. These coated mats are particularly suited for use in the manufacture of thermal and/or sound insulation composites, tack board, a component of office module construction, wallboard, and other like products.

The coating on the mat comprises a mixture of about 40 to about 90 wt. percent of pigments and/or fillers containing from about 1 to about 20 wt. percent of a platey mica having mean particle size within the range of about 38+/−8 or less and an aspect ratio in the range of about 36+/−7 or less, the remainder of the pigments and/or fillers comprising finely divided mineral, the pigments and/or fillers being bound together with about 3 to about 15 wt. percent of a binder, the coating weight being in the range of about 100 to about 500, more typically about 270+/−100 gms/sq. meter and the Gurley™ permeability of the coated mats is at least about 100 seconds, more typically 150 seconds or greater and most typically about 200 seconds or greater. Typically the coating comprises about 10+/−5 wt. percent of a binder, about 5+/−3 wt. percent of the platey mica, about 65+/−10 wt. percent of finely divided mineral pigment or filler having a mean particle size in the range of about 11 to about 17 microns and about 15+/−5 wt. percent of a finely divided mineral having a mean particle size in the range of about 20 to about 30 microns. Most typically the coating comprises about 10+/−3 wt. percent of a binder, about 6+/−2 wt. percent of the platey mica having a mean particle size of about 38+/−up to 1.5 microns, about 65+/−5 wt. percent of finely divided mineral pigment or filler having a mean particle size in the range of about 12+/−1 micron and about 18+/−3 wt. percent of a finely divided mineral having a mean particle size in the range of about 25+/−3 microns and a coating weight in the range of about 270+/−80 gms/sq. ft. The coating can also contain other functional ingredients adding up to about 10 wt. percent, more typically less than about 6 wt. percent and most typically less than about 5 wt. percent. These functional ingredients are described in the Detailed Disclosure section below.

The present invention also includes laminates comprising a substrate and a layer of a coated fibrous mat of the invention bonded to at least one surface of the substrate.

The present invention also includes a process of making the coating compositions described above comprising adding functional ingredients, excluding viscosity modifying agent(s), to a measured amount of water in a container and stir well, then add the proper amount of polymer binder and mix well, next add the proper amount of mica and mix well, next add the other pigments and/or fillers gradually while stirring and adjust the viscosity by adding a viscosity adjustment agent to achieve a viscosity in the composition in the range of about 10,000 centipoise to about 20,000 centipoise.

When the word “about” is used herein it is meant that the amount or condition it modifies can vary some beyond that so long as the advantages of the invention are realized. Practically, there is rarely the time or resources available to very precisely determine the limits of all the parameters of ones invention because to do would require an effort far greater than can be justified at the time the invention is being developed to a commercial reality. The skilled artisan understands this and expects that the disclosed results of the invention might extend, at least somewhat, beyond one or more of the limits disclosed. Later, having the benefit of the inventors disclosure and understanding the inventive concept and embodiments disclosed including the best mode known to the inventor, the inventor and others can, without inventive effort, explore beyond the limits disclosed to determine if the invention is realized beyond those limits and, when embodiments are found to be without any unexpected characteristics, those embodiments are within the meaning of the term about as used herein. It is not difficult for the artisan or others to determine whether such an embodiment is either as expected or, because of either a break in the continuity of results or one or more features that are significantly better than reported by the inventor, is surprising and thus an unobvious teaching leading to a further advance in the art.

### DETAILED DESCRIPTION OF THE INVENTION

The coating composition of the invention comprises the combination of a platey mica of a particular particle size range and aspect ratio range, one or more mineral pigments and/or fillers of certain particle sizes and an aqueous binder, and other functional ingredients such as one or more dispersants, defoamers, water repellents, and thickner/viscosity modifiers, colorants, biocides, fungicides, etc. The mean particle size of the mica and the aspect ratio are very critical to achieving the desired permeability with low coating weights. Typically the mean particle size of the platey mica is in the range of about 30 to about 46 microns, more typically from about 32 to about 44 microns, even more typically from about 35 to about 41 microns even more typically from about 36 to about 40 microns and most typically from about 38+/−0.5-1 microns, and the most desirable average particle size is 38 microns. The aspect ratio of the platey mica is typically in the range of about 36+/−7 microns, more typically about 36+/−5 microns, even more typically about 36+/−4 microns, most typically about 38+/−1.5 and most desirably about 38+/−0.5-1.

The coating compositions of the invention are those having a high PVC value, such as a PVC value above about 60 percent, most typically a PVC value of about 85% or higher. The PVC value is determined with the formula, PVC (pigment volume concentration)=Volume of the fillers/pigments×100% Volume of filler/pigments.+volume of binder

In the invention, the mica is treated as a filler or pigment along with the other filler(s) or pigment(s). In high PVC value coating compositions of the prior art, above 60 and 85 or higher, to get high Gurley™ number permeabilities in the coated fibrous mats, such as by coating fibrous mats having air perms of more than 500 and up to about 1,000 cubic feet per square foot at a pressure drop of 0.5 inches of water, required coating weights greater than 375 gms per square meter. The coating compositions of the invention produce these high Gurley™ air permeabilities with substantially lower coating weights in the range of about 190 to about 350 gms/sq. meter and most typically with coating weights in the range of about 240 to about 300 gms/sq. meter.

The other mineral pigments or fillers, frequently white, typically include white limestone having a mean particle size typically in the range of about 11 to about 17 microns, more typically about 12-16 microns and most typically about 13-15 microns with about 12-14 microns being most desirable, marble dust (calcium carbonate) having a mean particle size of about 20 to about 30 microns, more typically about 22-28 microns and most typically about 24-26 microns with 25 microns being most desirable. The typical content of mineral pigments, including the platey mica, is in the range of about 40-90, more typically about 40-80, and most typically about 40-73 wt. percent of the solids in the coating composition, and the binder content is typically about 3 to about 15 wt. percent of the solids, more typically about 4 to about 6 wt. percent and other functional ingredients comprise about 1 to about 10 wt. percent of the solids content. Of the total mineral pigments portion, the amount of platey mica is critical to the results and is present in amounts in the range of about 1 to about 20 wt. percent of the solids in the coating composition, more typically in the range of about 1 to about 15 wt. percent and most typically about 1 or 2 or 3 to about 7, 8, 9, 10, 11, 12, or 13 wt. percent. The other fillers or pigments, such as #10 white is typically present in amounts in the range of about 40-80, more typically about 40 to about 73 wt. percent of the solids in the coating composition, and marble dust is present in amounts in the range of about 10-40, more typically about 10 to about 20 wt. percent of the solids.

Any kind of platey mica, or other platey fillers, will be suitable providing it meets the particle size and aspect ratio limitations set out above. The other desirable feature of the mica is that its particle size distribution as defined by terms of art as a narrow to medium particle size distribution. The most typical mica used is KCM 200, available from Imery's of Roswell, Ga. or the Kish Company of Mentor, Ohio. A typical particle size distribution and other properties for the KCM-200 product, a platey Muscovite mica are as follows:

Oversize Fraction (%)¹

| | |
|---|---|
| +106 μm | 0.05 |
| +63 μm | 5.50 |
| +45 μm | 40.20 |
| +32 μm | 63.25 |

Particle Size Distribution (%)*²

| | |
|---|---|
| −176 μm | 98.93 |
| −88 μm | 84.46 |
| −44 μm | 40.08 |
| −22 μm | 11.69 |
| −11 μm | 1.04 |
| Mean Particle Diameter (μm) | 38*¹ |
| | 51.92*² |
| Average Particle Thickness (μm) | 1.49 |
| Average Aspect Ratio | 36.07*¹ |
| | 34.56*² |
| Bulk Density (Loose) (g/cm³) | 0.223 |

*¹Screen Analysis
*²Microtrac Analysis

The binders suitable typically include resins that can be put into aqueous solution or as emulsion and include styrene/butadiene binders including GoodRite™ 0706 (styrene butadiene rubber latex), available from Noveon, Inc. located in Cleveland, Ohio, a choice when good flexibility of the coated sheet is important and acrylic resins including Rhoplex™ NW 1845/Hycar™ 26391, available from Rhom and Haas Co. of Philadelphia, Pa., when good UV resistance and high stiffness are desirable in the coated mat. Other resin binders suitable for the coating compositions include ethylene-vinyl chloride, polyvinylidenechloride, modified polyvinylchloride, polyvinyl alcohol, ethylene vinyl acetate, polyvinyl acetate, ethylacrylate-methylmethacrylate acrylic copolymer latex, non-carboxylated acrylic with acrylonitriles copolymer latex, carboxylated butyacrylic copolymer latex, urea-formaldehyde latex, melamine-formaldehyde latex, polyvinylchloride-acrylic latex, methylmethacrylate-styrene copolymer latex, styrene-acrylic copolymer latex, phenol-formaldehyde latex, vinyl-acrylic latex, polyacrylic acid latex and other similar resin binders.

The criteria for selecting the type of binder are most dependent upon the properties desired in the coated mat. Other styrene/butadiene resin binders suitable include Styrofan™ ND 593 and Butonal™ NX 1129, both available from the BASF Corp. of Florham Park, N.J. Other binders suitable typically include carboxyl methyl cellulose, hydroxyl ethyl cellulose, lignosulfonates, urea formaldehyde resins modified in known ways to plasticize the binder and to provide higher wet strengths, cellulose gums and other similar resins. The criteria for selecting a suitable binder are those that produce a required viscosity under both low and high shear in the coating composition. By required viscosity is meant a viscosity in the range of 6,000 centipoise to about 20,000 centipoise (3 RPM, Spindle No. 4), more typically a range of about 10,000 to about 15,000, even more typically about 8,000 to about 12,000 centipoise. The criteria for selecting the type of binder are most dependent upon the rheological properties desired for the coating process and technology in use and upon the properties desired in the coated mat. Other styrene/butadiene resin binders suitable include Styrofan™ ND 593 and Butonal™ NX 1129, both available from the BASF Corp. of Florham Park, N.J. Typical resin based binders meeting this description include those shown in Table 1.

TABLE 1

| | | | Surface | | | Solids |
|---|---|---|---|---|---|---|
| | Chemical | | Tension | | Particle | Content |
| Latex | Composition | Tg (° C.) | (dynes/cm) | pH | Size (μ) | (%) |
| Acrylic | | | | | | |
| Hycar 26391 | Styrene + MMA + (soft | 37 | 54 | 3.6 | | 49 |
| (Vendor | EA + nBA), | | | | | |
| Noveon) | major is soft | | | | | |
| | segment | | | | | |
| Rhoplex NW- | Styrene/Acrylic | −21 | | 6.7 | | 44 |
| 1845 (Vendor | | | | | | |
| Rohm & Haas) | | | | | | |
| GL 618 (Vendor | Acrylic | 36 | 50 | 8.6 | | 47 |
| Rohm & Haas) | | | | | | |
| Acrygen 60110 | Styrene/Acrylic | | | | | |
| (Vendor: | | | | | | |
| Omnova) | | | | | | |
| Ucar 627 (Dow | Acrylic | 15 | | 9.8 | 0.11 | 43.5 |
| Chemicals) | | | | | | |
| Ucar 625 (Dow | Acrylic | 12 | | 9 | | 50 |
| Chemicals) | | | | | | |
| Ucar 100 (Dow | Styrene/acrylic | 12 | | 6 | 0.3 | 62 |
| Chemicals) | | | | | | |
| Ucar 300 (Dow | Vinyl/acrylic | 5 | | 5 | 0.28 | 55 |
| Chemicals) | | | | | | |
| Ucar 629 (Dow | Acrylic | 5 | | 7–8 | 0.15–0.21 | 55 |
| Chemicals) | | | | | | |
| Dow 9192 (Dow | Acrylic | 0 | | 4 | | 66 |
| Chemicals) | | | | | | |
| Ucar 154S | Acrylic | −4 | | 4.5 | 0.34 | 60 |
| (Dow | | | | | | |
| Chemicals) | | | | | | |
| Urethane- | | | | | | |
| Acrylic Hybrid | | | | | | |
| Polymer | | | | | | |
| Hybridur 560 | Acrylic/ | | | 7.5–8.5 | colloidal | 40–45 |
| (Air Products) | Polyurethane | | | | | |
| Hybridur 570 | Acrylic/ | | | 7.5–8.5 | colloidal | 40–42 |
| (Air Products) | Polyurethane | | | | | |
| Hybridur 580 | Acrylic/ | | | 7.5–8.5 | colloidal | 40–42 |
| (Air Products) | Polyurethane | | | | | |
| Non-acrylic | | | | | | |
| Airflex 9100 (Air | Ethylene vinyl | −30 | | 5 | | 49 |
| Products) | acetate | | | | | |
| Airflex EF811 | Ethylene vinyl | 12 | | 4–5 | 0.23 | 55 |
| (Air Products) | acetate | | | | | |
| Neocar 2535 | Vinyl ester | 10 | | 5 | | 53.5 |
| (Dow | | | | | | |
| Chemicals) | | | | | | |
| Neocar 2300 | Vinyl ester | 20 | | 5 | 0.3 | 55 |
| (Dow | | | | | | |
| Chemicals) | | | | | | |
| Vycar 1022 | Vinyl acetate | 32 | | 4–6 | >1.0 | 55–58 |
| (Noveon) | | | | | | |
| Styrene | | | | | | |
| Butadiene | | | | | | |
| Rubber | | | | | | |
| GoodRite 0706 | Styrene/ | 20 | 61 (dynes/cm) | 8.5 | | 52 |
| (Noveon) | butadiene | | | | | |
| Styrofan ND | Styrene/ | 5 | 46 mN/m | 8.4–9.2 | 0.17 | 50–52 |
| 593 (BASF) | butadiene | | | | | |
| Butonal NX | Styrene/ | −56 | | 10.0–10.7 | | 69–72 |
| 1129 (BASF) | butadiene | | | | | |

The coating compositions can also include other ingredients such as dispersants, pH adjusting materials like acids and bases, water repellants, defoamers, viscosity adjusting materials, fungicides, anti-bacterial materials, fire retardants, etc. The amounts of these functional ingredients will be the amounts needed to achieve the function for which they are added. Some functional ingredients are more effective than others but a less effective ingredient may be selected because of cost, availability, or other reason as is well known.

The coating compositions of the invention are prepared by adding the ingredients to water. A most typical order of addition, but not a necessary order, is to add the functional ingredients, except for the viscosity modifier, first, and to mix is any suitable slurry mixer. While the slurry mixer is running the aqueous binder is then added and after mixing, the mica is added and thoroughly dispersed. Next the pigments are added and dispersed. Then the viscosity is measured, such as with a Brookfield Viscometer. The viscosity range suitable for coating is a range of about 6,000 centipoise to about 20,000 centipoise (3 RPM, Spindle No. 4), more typically a range of about 12,500 to about 17,500 centipoise and most typically about 15,000+/−up to 1,000 or up to 2,000 centipoise. If the viscosity is too high, more water or more dispersant or both are added until the viscosity is within the desired range. If the viscosity is too low, a viscosity modifier, a thickening agent, is added slowly until the viscosity is within the desired range for coating. All viscosities stated herein, including the claims, are those measured with a Brookfield Visocmeter using Spindle No. 4 and 3 RPM.

Mats for coating in the present invention contain continuous or chopped fibers bonded together with a binder and can contain additives like one or more pigments, fillers, fire retardants, intumescent materials, or other functional materials. The majority of the fibers are most typically glass fibers, but can be synthetic polymer or natural fibers and also mixtures of two or more of these fibers. The glass fibers used to make mats can have various fiber diameters and lengths, including lengths longer than either dimension of the mat, dependent on the strength and other properties desired in the mat as is well known. It is preferred that the majority of the glass fibers have diameters in the range of about 2 up to about 30 microns or higher, with the major portion of the fiber being preferably in the range of about 6-23 microns, e.g. 10 to 19 microns and most typically in the range of about 13 to 17 microns, such as 15-17 microns. Mats made from fibers having diameters of about 13 microns or less are easier to coat because the openings between the fibers are smaller than if the diameter of the fibers are significantly greater than 13 microns, such as 15 microns or larger.

The glass fibers can be E glass, C glass, T glass, S glass or any known glass fiber of good strength and durability in the presence of moisture. Normally the glass fibers used all have about the same target length, such as 0.25, 0.5, 0.75, 1 or 1.25 inch, or longer but fibers of different lengths and different average diameters can also be used to get different characteristics in a known manner. When the mat contains chopped fibers the lengths can be up to about 3-5 inches in length if made in a wet process such as those used for making glass fiber mats and even longer fibers can be used in some dry processes. The mats for use in the invention can also be made from continuous fibers, either well dispersed or contained in strands of 10 to several hundred or thousands of fibers, normally called veil mats and continuous strand mats respectively. Generally the longer the fiber the higher the tensile and tear strengths of the mat, but the less complete the dispersion of the chopped fiber strands into individual fibers and the larger the openings between the fibers, particularly at the surfaces of the mat. Larger openings between the fibers at the surface(s) of the mat, the surface(s) to be coated, typically requires a heavier coating weight to properly coat the mat.

The binders used to bond the fibers together are preferably resins that can be put into aqueous solution or emulsion latex. Typical resin based binders meeting this description are polyvinyl alcohol, carboxyl methyl cellulose, hydroxyl ethyl cellulose, lignosulfonates, urea formaldehyde resins modified in known manner to plasticize the binder and to provide higher wet strengths, cellulose gums and other similar resins. Of these, conventional modified urea formaldehyde resins are much preferred because of their cost, bonding strength to fibers, particularly glass fibers, and acceptability for various applications.

Most typically the woven and nonwoven fibrous mats used in the invention are made using one of the well known wet processes used to make woven and nonwoven mats such as various looms, inclined wire wet forming processes as disclosed in the first paragraph of the Background section above, but fibrous nonwoven mats made on conventional dry processes are also suitable for coating by the invention. Some of the nonwoven mats most typically used in the present invention include nonwoven mats comprising about 70-85 wt. percent fibers of any type, the fibers typically having a length of from about 0.6 mm to about 40 mm, the fibers bound together with about 4 to about 30 wt. percent of a cured or partially cured resin or inorganic binder. The fibers can be any kind of fiber and most typically are glass fibers, polymer fibers or blends of these fibers with or without some cellulosic fibers being present. The types of glass fibers or polymer fibers are not critical. The Fraser air permeabilities of typical fibrous nonwoven mats are usually in the range of about 500-800 cubic feet per square foot. In this disclosure, nonwoven mats made and sold by the Johns Manville Corporation, including nonwoven fibrous mats identified as DuraGlas™ 7512, 7594 and 7611 fiber glass nonwoven mats, were coated. These mats are comprised of E glass fibers bound together with a resin binder and have properties as shown in Table 2 below.

TABLE 2

| | | Mat Wt. | | |
|---|---|---|---|---|
| Mat Type | Thickness (mim) | (gms/sq. meter) | LOI % | Air Perm.* |
| 7512 | 0.53 +/− .07 | 54.4 | 24 | 700–950 |
| 7594 | 0.89 +/− .07 | 103 | 20 | 600 |
| 7611 | 0.74 +/− .07 | 90 | 19 | 650 |
| 8829 | 0.89 +/− .07 | 117.5 | 25 | 700–950 |

*Frasier

The permeabilities of these types of mats are relatively high. While they provide good stabilization and strength when used as a facer on foam, gypsum wallboard, ceiling tile, insulation, and many other types of products, their surface is not suitable for painting to provide an esthetic surface. However, when coated according to the present invention, with a very low coating weight, they present an exposed surface that is very smooth and suitable for the process (wallboard, foamboard, etc.) and for painting and for resulting in a pleasing esthetic surface, while the coated nonwoven mat facer is mold resistant and has other unique properties.

The mats described above when coated according to the invention with the compositions described above using any known coating method, including knife over roll, slot/dye, dip coating, spray coating, foam coating and others. The dip coating or knife over roll technology are most typically used in the examples herein. The fibrous nonwoven mats to be coated usually are in rolls of various widths and roll diameters or mat lengths. To coat the mat, the roll is mounted on a pay-off stand and the leading edge of the mat is fed into a pulling device on the coating line. The latter pulls and conveys the mat beneath the coater where a thin layer of a coating composition of the invention is applied to the mat, and optionally, the excess coating is scraped or doctor bladed from the top surface of the mat. The coated mat is then run through an oven to dry the coating and mat and to cure the resin in the coating. The coated mat is then cut into lengths or rolled up into rolls for storage and/or shipment.

The coated facer mats of the invention have a coating weight in the range of about 270 grams/square meter (g/sm) plus/minus about 80 g/sm, more typically a coating weight in a range of about 240 to about 300 g/sm, have a Gurley™ Densometer™ air permeability of at least about 0 seconds or less to about 400-450 seconds, and are suitable for an exposed face of wall board, exposed surface of various ceiling tiles, exposed surfaces of foam board and many other applications. By zero seconds or less is meant that the permeability of the coated mat is greater at the end of the capability range of the Gurley Densonater™ and requires a different test method, but in any case is substantially below a Frasier perm of 100 CFM/sq. ft. One of the key reasons for the low permeability of the coated surfaces of the coated mats of the present invention, in spite of their very low coating weights, is the presence and size/shape of the mica, and much of that mica being oriented parallel or nearly parallel to the surface of the coating. By nearly parallel means within about 45 degrees of being exactly parallel to the exposed surface of the coating.

Air permeability can be measured using many different known methods, e.g., it can be measured in seconds of a known amount of air mass to pass through the web, as measured by instruments such as the “Gurley Densonater™.” Generally, the air permeability of the coated mats of the present invention range from less than 0 seconds as measured on this Gurley™ device (outside the range for this Gurley™ device), but more typically is greater than about 200 Gurley™ seconds, and most preferably greater than 300 Gurley seconds and up to about Gurley™ 450 seconds. The air permeability of a mat can also be conventionally measured by the air flow between reservoirs separated by the mat using a test called the Frazier test, which is further described by ASTM Standard Method D737, with the results ordinarily being given in units of cubic feet per minute per square foot (cfm/ft²). The test is usually carried out at a differential pressure of about 0.5 inches of water.

### EXAMPLE 1

A coating composition was prepared by adding the following ingredients and amounts:
209.33 grams water (21.8 wt. %)
4 gms of Carbowet™ DC 01 (0.42 wt. %)
0.21 gms BYK-037 (0.021 wt. %)
79.3 gms Goodrite™ 0706 (8.26 wt. %)
45.7 gms KCM-200 (4.76 wt. %)
476.6 gms #10 White (49.67 wt. %)
130.6 gms Marble Dust (13.6 wt. %)
13.84 gms Rheolate™ 278 (1.44 wt. %)*

### *The actual amount of the thickener will vary depending upon the water being used and the nature or surface area of the fillers/pigments particles which will vary somewhat from lot to lot.

The above coating slurry was mixed in a container and the viscosity was adjusted to be within a range of about 6000-20,000 by the addition of the Rheolate™ 278, a thickener available from Elemintis, Inc. The Carbowet™ DC 01 is a dispersant of 50% concentration available from Air Products Corp. The Goodrite™ 0706 is a styrene/butadiene rubber binder of 53% solids and is described earlier. The KCM-200 is the mica described earlier. The #10 White and Marble Dust are described above and are ground calcium carbonate pigments/fillers available from Imery's Company or Roswell, Ga.

The above coating composition was then used to coat a fiber glass nonwoven mats, Johns Manville Corp.'s 7512, 7594, 7611 and 8229 mats on a conventional dipping and knife over roll coater to several coating weights and dried and cured at 130-140 degrees C. for about 20-30 seconds, producing coated mats having the coating weight and Gurley permeability as shown in Table 1 below.

TABLE 3

| Mat | Coating | Permeability | Ratio of |
|---|---|---|---|
| Type | Wt. (gms/sq. meter) | Gurley ™ (seconds) | Gurley ™/coat wt. |
| 7611 | 270 | 190 | 0.7037 |
| 7611 | 320 | 480 | 1.5 |
| 7512 | 260 | 300 | 1.4615 |
| 7512 | 315 | ≧400 | 1.2698 |
| 8229* | 200 | 20 | 0.1 |

*Contains both glass fibers and polymer fibers.

The above coated mats of the invention having a coat weight of at least about 260 gms/sq. meter had a very smooth surface and had a very desirable surface for exposure on residential, commercial and institutional walls and ceilings. Also, the coated mats of the invention had much lower air permeabilities compared to that of prior art coated 7512, 7594 and 7611 mats in which the prior art coatings had to be applied to in substantially greater weights per square meter to achieve the same desired low permeability and quality of coated surface as shown below. Note that the ratio of Gurley™ permeability in seconds to coating weight in gms/sq. meter is also substantially higher when the coating weight is 260 gms/sq. meter or above, and indications are that even significantly lower coating weights would still produce a Gurley™ number above 200 on mats like or similar to the 7512 mat.

### EXAMPLES 2-6

Various coating compositions were prepared in the same manner as the coating composition in Example 1 except that the composition was varied by using different proportions of fillers/pigments, different mica particle size and different filler/pigment particle size as shown in Table 4 below. These various coating compositions were then used to coat 7594 mat in the same manner as followed in Example 1. Also shown in Table 3 below are the coating weights and the Gurley permeability of the various coated mats made in Examples 2-6.

TABLE 4
Effect of Mica on CPVC & Gurley (air permeability)

| | Filler (wt. percent) | | | | | | | | |
|---|---|---|---|---|---|---|---|---|---|
| | | | | Platey Mica | | | | | |
| | | | #10 | Mineralite | | | | | |
| | Atomite | Marble | White | 4 × | KCM 200 | PVC | CPVC^{a} | Coat | Gurley |
| Formulation | (3μ) | Dust (20μ) | (14μ) | (7–11μ) | (38μ) | (%) | (%) | Wt (g/sq m) | (Sec.) |
| 2 | 100 | | | | | 86 | 58 | 290 | 12 |
| 3 | | | 97 | 3 | | 85 | 64 | 293 | 34 |
| 4 | | 20 | 73 | | 7 | 86 | 63 | 270 | 180 |
| 5 | | | 90 | 10 | | 85 | 63 | 306 | 31 |
| 6 | 20 | | 77 | 3 | | 85 | 63 | 252 | 4 |

^{a}The CPVC calculation was based on the formula below.

$$CPVC = \frac{1}{1 + \frac{{\sum }_{i}^{ } {( OA )}_{i} {ρ}_{i} {V}_{i}}{93.5}} * 100 \%$$

where, OAᵢ: Oil absorption number of i^{th} fille□_{□}: p is the Density in g/ml of i^{th} filler, Vᵢ:is the Volume fraction of i^{th} filler, 93.5 is the Density of linseed oil times 100 (linseed oil is used to calculate the oil absorption number of inorganic fillers) and CPVC is expressed in %. In the calculations, the mica is considered as spherical in shape and the parameters used to calculate CPVC were as follows in Table 5 below:

TABLE 5

| | Mean | | |
|---|---|---|---|
| | Size | Oil | |
| Material | (μ) | Absorption | Density |
| Mineralite | 7–11 | 34 | 2.73 |
| 4X | | | |
| KCM 200 | 38 | 45 | 2.23 |
| #10 | 14 | 19 | 2.722 |
| White | | | |
| Marble | 20 | 18^{b} | 2.722 |
| Dust | | | |
| Atomite | 2.5 | 25^{c} | 2.7 |

*Atomite ™ 2.5 micron ground calcium carbonate available from Eager Plastics, Inc. of Chicago, IL.
#Mineralite 4X (7–11 micron) mica available from Englehard Corp. of Iselin, NJ.

When the ratio of Gurley™ permeability to coating weight, as done in Example 1 above, they are as follows: Example 2-0.0414, Example 3-0.1160, Example 4-0.6667, Example 5-0.1013 and Example 6-0.0159. This ratio also shows the effectiveness of the platey mica on the coating composition. The low coating effectiveness ratio on the 8829 fibrous nonwoven mat is attributed to a substantial volume percentage of polymer fibers contained in the 8829 mat. Possibly because of the larger diameter of the polymer fibers in the mat (larger diameter than the glass fibers in the mat) resulting in larger openings in the mat surface or because of a lower affinity of the polymer fibers for the coating composition, or both, the coating compositions have a lower coating effectiveness on mats containing a substantial volume percentage of polymer fibers. When this and other data was analyzed further it showed that the compositions of the invention are particularly effective in providing high Gurley™ number permeabilities when this ratio is at least about 0.3 based on the coating compositions being coated on fibrous nonwoven mats containing a major portion of glass fibers and no significant amount of polymer fibers, the mats having a Frasier permeability in the range of 400 to about 1000 CFM/sq. ft.

The data in Table 4 shows the criticality of the presence of small amounts of platey mica and the particle size of the mica in the coating composition to the low permeability (Gurley™ exceeding 100 seconds) with low coating weights, when used as a coating on nonwoven fibrous mats having an uncoated permeability of at least 400-500 CFM/sq. ft. The particle size of mica (or any platy fillers) plays a significant role in reducing the air permeability at low coat wt. The mean particle size of 38μ had significant effect upon the ratio of Gurley to coat wt (Table 4, formulation 4, 0.66). Use of mean particle size 44μ (mica) did not resulted in high gurley to coat wt ratio (≦0.2 in lab sample). The narrow range of particle size distribution have also an impact in reducing the air permeability significantly once the particle size is identified for the coating composition.

### EXAMPLE 7

Laboratory data in Table 5 below show that increases in mica percentage in the coating composition produce higher Gurley™ number perm when coated at about the same coating weight on the same type of mat. However, the dispersion of mica in the coating mixture could be the key to utilize the benefit of mica in the coating composition.

TABLE 5

| | Coating | Permeability | Wt. percentage |
|---|---|---|---|
| Mat Type | Wt. (gms/sq. meter) | Gurley ™ (seconds) | of Mica |
| 7594 | 328 | 28 | 5 |
| 7594 | 330 | 110 | 7 |

b: in general with increase in mica percentage the air permeability gets reduced.

Having the benefit of the above disclosure, many other modifications will be obvious to the skilled artisan, all of which, and their equivalents, are intended to be included in the scope of the following claims.

1. An aqueous coating composition comprising about 40 to about 90 wt. percent of finely divided mineral pigments or fillers and about 3 to about 15 wt. percent of a binder, the filler or pigment comprising from about 1 to about 20 wt. percent of a platey filler having a mean particle size of 38+/−8 microns and an aspect ratio of 36+/−7, the coating composition having a Brookfield viscosity in the range of about 6000 to about 20,000 centipoise, all the wt. percentages based on the total weight of the composition.

2. The aqueous coating composition of claim 1 wherein the pigments and fillers include calcium carbonate materials, one having a mean particle size typically in the range of about 11 to about 17 microns and the another having a mean particle size of about 20 to about 30 microns.

3. The aqueous composition of claim 1 wherein the platey filler is mica and the composition will produce a ratio of Gurley™ number permeability to coating wt. on a fibrous mat having a perm of about 400 to about 1000 of at least about 0.3 when coated on a fibrous nonwoven mat containing a major portion of glass fibers and no significant amount of polymer fibers, the mat having a permeability in the range from about 100-400 to about 1000 CFM/sq. ft.

4. The aqueous composition of claim 2 wherein the platey filler is mica and the composition will produce a ratio of Gurley™ number permeability to coating wt. on a fibrous mat having a perm of 100-1000 of at least about 0.3 when coated on a fibrous nonwoven mat containing a major portion of glass fibers and no significant amount of polymer fibers, the mat having a permeability in the range of about 100-400 to about 1000 CFM/sq. ft.

5. The aqueous composition of claim 2 wherein the platey filler is mica and the mineral fillers or pigments content is in the range of about 40 to about 80 wt. percent, the platey mica content is in the range of about 2 to about 15 wt. percent having a mean particle size of about 38+/−6 microns and an aspect ratio in the range of about 36+/−5 and the other pigments and fillers have average particle sizes in the ranges of about 12-16 microns and 22-28 microns respectively.

6. The aqueous composition of claim 3 wherein the mineral fillers or pigments content is in the range of about 40 to about 80 wt. percent, the platey mica content is in the range of about 2 to about 15 wt. percent having a mean particle size of about 38+/−6 microns and an aspect ratio in the range of about 36+/−5 and the other pigments and fillers have average particle sizes in the ranges of about 12-16 microns and 22-28 microns respectively.

7. The aqueous composition of claim 4 wherein the mineral fillers or pigments content is in the range of about 40 to about 80 wt. percent, the platey mica content is in the range of about 2 to about 15 wt. percent having a mean particle size of about 38+/−6 microns and an aspect ratio in the range of about 36+/−5 and the other pigments and fillers have average particle sizes in the ranges of about 12-16 microns and 22-28 microns respectively.

8. The aqueous composition of claim 2 wherein the platey filler is mica and the mineral fillers or pigments content is in the range of about 40 to about 73 wt. percent, the platey mica content is in the range of about 5 to about 10 wt. percent having a mean particle size of about 38+/−4 microns and an aspect ratio in the range of about 36+/−5 and the other pigments and fillers have average particle sizes in the ranges of about 12-15 microns and 24-26 microns respectively.

9. The aqueous composition of claim 3 wherein the mineral fillers or pigments content is in the range of about 40 to about 73 wt. percent, the platey mica content is in the range of about 5 to about 10 wt. percent having a mean particle size of about 38+/−4 microns and an aspect ratio in the range of about 36+/−5 and the other pigments and fillers have average particle sizes in the ranges of about 12-15 microns and 24-26 microns respectively.

10. The aqueous composition of claim 4 wherein the mineral fillers or pigments content is in the range of about 40 to about 73 wt. percent, the platey mica content is in the range of about 5 to about 10 wt. percent having a mean particle size of about 38+/−4 microns and an aspect ratio in the range of about 36+/−5 and the other pigments and fillers have average particle sizes in the ranges of about 12-15 microns and 24-26 microns respectively.

11. The aqueous composition of claim 1 wherein the viscosity is in the range of about 6000 to about 15,000 centipoise.

12. The aqueous composition of claim 2 wherein the viscosity is in the range of about 6000 to about 15,000 centipoise.

13. The aqueous composition of claim 3 wherein the viscosity is in the range of about 6000 to about 15,000 centipoise.

14. The aqueous composition of claim 4 wherein the viscosity is in the range of about 6000 to about 15,000 centipoise.

15. The aqueous composition of claim 5 wherein the viscosity is in the range of about 6000 to about 15,000 centipoise.

16. The aqueous composition of claim 6 wherein the viscosity is in the range of about 6000 to about 15,000 centipoise.

17. The aqueous composition of claim 7 wherein the viscosity is in the range of about 6000 to about 15,000 centipoise.

18. The aqueous composition of claim 8 wherein the viscosity is in the range of about 6000 to about 15,000 centipoise.

19. The aqueous composition of claim 9 wherein the viscosity is in the range of about 6000 to about 15,000 centipoise.

20. The aqueous composition of claim 10 wherein the viscosity is in the range of about 6000 to about 15,000 centipoise.

21. An aqueous coating composition comprising about 21-22 wt. percent water, about 5 to about 7 wt. percent platey mica having a mean particle size of 38+/−1.5 microns and an aspect ratio of about 36+/−5, about 47.6 to about 49 to about 50 wt. percent of a ground calcium carbonate mineral having a mean particle size of about 11 to about 14 microns, about 13 to about 14 wt. percent of a ground mineral filler or pigment having a mean particle size of about 24 to about 26 microns, about 3 to about 6 wt. percent of a binder, the viscosity of the coating composition being in the range of about 6,000 to about 15,000.

22. The aqueous composition of claim 21 wherein the binder contains a styrene.

23. The aqueous composition of claim 21 wherein the composition also comprises effective amounts of one or more ingredients selected from a group consisting of dispersants, water repellants, viscosity modifiers, pH adjusting materials, defoamers, fungicides, anti-bacterial materials, fire retardants.

24. The aqueous composition of claim 22 wherein the composition also comprises effective amounts of one or more ingredients selected from a group consisting of dispersants, water repellants, viscosity modifiers, pH adjusting materials, defoamers, fungicides, anti-bacterial materials, fire retardants.

25. A method of making an aqueous coating composition comprising about 40 to about 90 wt. percent of finely divided mineral pigments or fillers and about 3 to about 15 wt. percent of a binder, the mineral filler or pigment comprising from about 1 to about 20 wt. percent of platey filler having a mean particle size of 38+/−8 microns and an aspect ratio of 36+/−7, the coating composition having a Brookfield viscosity in the range of about 6000 to about 20,000 centipoise, all the wt. percentages based on the total weight of the composition, the method comprising the steps of:
a) adding the water to a container,
b) adding any functional ingredients except for viscosity modifier to the water and stirring,
c) adding the binder while stirring,
d) while stirring add the platey filler and thoroughly dispersing,
e) while stirring add the pigments and fillers to thoroughly disperse,
f) measure the viscosity of the mixture and add a viscosity modifier if necessary to bring the viscosity within the range of about 6,000 to about 20,000.

26. The method of claim 25 wherein the pigments and fillers include calcium carbonate materials, one having a mean particle size typically in the range of about 11 to about 17 microns and the another having a mean particle size of about 20 to about 30 microns.

27. The method of claim 25 wherein the platey filler is mica and the composition will produce a ratio of Gurley™ number permeability to coating wt. on a fibrous mat having a perm of 400-1000 of at least about 0.3 when coated on a fibrous nonwoven mat containing a major portion of glass fibers and no significant amount of polymer fibers, the mat having a permeability in the range of about 100-400 to about 1000 CFM/sq. ft.

28. The method of claim 26 wherein the platey filler is mica and the composition will produce a ratio of Gurley™ number permeability to coating wt. on a fibrous mat having a perm of 100-1000 of at least about 0.3 when coated on a fibrous nonwoven mat containing a major portion of glass fibers and no significant amount of polymer fibers, the mat having a permeability in the range of about 100-400 to about 1000 CFM/sq. ft.

29. A coated fibrous mat, the mat comprising a major portion of glass fibers bound together with a resin binder, the coating on the mat comprising a mixture of about 40 to about 90 wt. percent of pigments and/or fillers containing from about 1 to about 20 wt. percent of a platey filler having mean particle size within the range of about 38+/−8 microns or less and an aspect ratio in the range of about 36+/−7 or less, the remainder of the pigments and/or fillers comprising finely divided mineral, the pigments and/or fillers being bound together with about 3 to about 15 wt. percent of a binder, the coating weight being in the range of about 100 to about 500 and the permeability of the coated mat being greater than about 0 seconds Gurley™.

30. The coated mat of claim 29 wherein the platey filler is mica and the coating binder content is about 10+/−4 wt. percent, the platey mica content is about 5+/−3 wt. percent, the mean particle size of the mica is about 38+/−3 microns, the remainder of the pigments and fillers comprise about 65+/−10 wt. percent of a first material having a mean particle size of about 11 to about 17 microns, about 15+/−5 wt. percent of a second material having a mean particle size in the range of about 25+/−5 microns, the coating weight is in the range of about 300+/−80 and the permeability of the coated mat is at least about 100 seconds.

31. The coated mat of claim 29 wherein the platey filler is mica and the coating binder content is about 10+/−3 wt. percent, the platey mica content is about 6+/−2 wt. percent, the mean particle size of the mica is about 38+/−1.5 microns, the remainder of the pigments and fillers comprise about 65+/−5 wt. percent of a first material having a mean particle size of about 12+/−1 microns, about 18+/−2 wt. percent of a second material having a mean particle size in the range of about 25+/−3 microns, the coating weight is in the range of about 270+/−80 and the permeability of the coated mat is at least about 150 seconds.

32. The coated mat of claim 29 wherein the coated mat contains no significant amount of polymer fibers.

33. The coated mat of claim 30 wherein the coated mat contains no significant amount of polymer fibers.

34. The coated mat of claim 31 wherein the coated mat contains no significant amount of polymer fibers.

35. A coated fibrous nonwoven mat comprising glass fibers bound together with a resin binder, coated on at least one surface with a coating comprising about 6+/−3 wt. percent of a binder and a mixture of about 40 to about 90 wt. percent of pigments and/or fillers containing about 6+/−2 wt. percent of a platey filler having mean particle size within the range of about 38+/−2 microns or less and an aspect ratio in the range of about 36+/−7 or less, the remainder of the pigments and/or fillers comprising about 65+/−5 wt. percent of a first material having a mean particle size of about 12+/−1 microns, about 18+/−2 wt. percent of a second material having a mean particle size in the range of about 25 +/−3 microns, the coating weight is in the range of about 270+/−80 and the permeability of the coated mat is at least about 150 seconds.

36. The coated mat of claim 35 wherein the platey filler is mica and the coating also comprises about 1-10 wt. percent of effective amounts of one or more ingredients selected from a group consisting of dispersants, water repellents, viscosity modifiers, pH adjusting materials, defoamers, fungicides, anti-bacterial materials and fire retardants.

37. The coated mat of claim 35 wherein the permeability of the coated mat is above about 180 seconds and the fibrous mat contains no significant amount of polymer fibers.

38. The coated mat of claim 36 wherein the mat contains no significant amount of polymer fibers.

39. A laminate comprising a substrate with a coated fibrous mat bonded to at least one surface of the substrate, the coated fibrous mat comprising a mixture of about 40 to about 90 wt. percent of pigments and/or fillers containing from about 1 to about 20 wt. percent of a platey filler having mean particle size within the range of about 38+/−8 microns or less and an aspect ratio in the range of about 36+/−7 or less, the remainder of the pigments and/or fillers comprising finely divided mineral, the pigments and/or fillers being bound together with about 3 to about 15 wt. percent of a binder, the coating weight being in the range of about 100 to about 500 and the permeability of the coated mat being greater than about 0 seconds Gurley™.

40. The laminate of claim 39 wherein the platey filler is mica and the coated fibrous mat is a nonwoven mat comprising glass fibers bound together with a resin binder and wherein the coating comprises 1-10 wt. percent of effective amounts of one or more ingredients selected from a group consisting of dispersants, water repellants, viscosity modifiers, pH adjusting materials, defoamers, fungicides, anti-bacterial materials and fire retardants.
